(19) United States
(12) Patent Application Publication
(10) Pub. No.: US 2010/0113674 A1
(43) Pub. Date: May 6, 2010

(54) METHACRYLATE ADHESIVE

(76) Inventor: RICHARD M. STRAND, Hampstead, NH (US)

Correspondence Address: FAY SHARPE LLP, 1228 Euclid Avenue, 5th Floor, The Halle Building, Cleveland, OH, 44115, US

(21) Appl. No.: 12/570,282

(22) Filed: Sep. 30, 2009

Related U.S. Application Data
(60) Provisional application No. 61/110,229, filed on Oct. 31, 2008.

(51) Int. Cl. C09J 133/12; C09J 175/00

(52) U.S. Cl. 524/507; 525/125; 525/108

(57) ABSTRACT

An adhesive composition that includes acrylic based monomer and/or methacrylic ester based monomer, an impact modifier; and an elastomer that includes urethane elastomer. The impact modifier includes methacrylate-butadiene-styrene copolymer.

The present invention claims priority on U.S. Provisional Patent Application Ser. No. 61/110,229 filed Oct. 31, 2008; which is incorporated herein by reference.

The present invention is directed to adhesives, and more particularly to an adhesive that includes acrylic and/or methacrylic esters, a urethane elastomer and an impact modifier.

### BACKGROUND OF THE INVENTION

There are a variety of different types of two part adhesives. These types can be further classified as 10:1, 4:1 or 1:1 mix ratio adhesives. Two part adhesives are made by mixing two or more components that chemically react with each other to form a chemically cross-linked adhesive. Two common types of two part adhesives are polyurethane and methacrylate adhesives. With each of these type of adhesives, there are a number of beneficial applications as well as characteristics which could be improved.

Polyurethane adhesives generally consist of an isocyanate-terminated polyol and a hardener or curative component that includes a polyol or amine or a combination of polyols and amines. These adhesives require a catalyst, heat or air evaporation to initiate and complete curing of the adhesive.

Polyurethanes are generally considered to be flexible, elastic and tough, but they also suffer from sensitivity to surface contamination, moisture and humidity. Despite many beneficial characteristics of polyurethane adhesives, fast-curing polyurethane adhesive products tend to have very short “open” working time after mixing, and products with more acceptable “open” times generally have very long cure times. This limitation of polyurethanes is imposed by the linear reaction mechanism that is characteristic of the addition polymerization reaction by which the polyurethanes cure. Elasticity, toughness and flexibility are beneficial when adhesive bonds are subjected to peeling or impact forces, and when bonds and bonded assemblies are subjected to dynamic fatigue stresses. However, polyurethanes have limited use for bonding to metals, and are generally more suitable for bonding to plastic materials in applications that are subjected to bending and impact stresses.

The methacrylate adhesive technology of today has evolved considerably since the development of what is referred to as the second generation technology of the mid to late 1980s. The technologies used in this family of adhesives are generally segregated based upon the curing mechanism use and the combination ratio that generally fits the required catalyst component levels in the “A” and “B” components. The “ten to one” ratio products generally use benzoyl peroxide (BPO) as a catalyst in the smaller ratio “B” component. The “A” component generally uses an amine initiator such as hydroxy ethyl toluidine (HET), dimethyl analine (DMA) or dimethyl para toluidine (DMPT). The type and incorporation levels of these amines can directly influence the cure speed of the adhesive. The same is true for the concentration of BPO in the “B” component. The speed of the cure in the 10:1 systems can also be varied through the use of secondary reactive monomer systems such as styrene or chain transfer agents. The molecular weight of the resulting polymer will also be influenced by these materials.

The ten to one ratio methacrylate adhesive systems generally make use of two toughening elastomers in combination to achieve their unique properties. Earlier methacrylate adhesives were very brittle, yielding failures at the very low strain level of 2% in tension. The use of solution grade elastomers such as neoprene, nitrile and butadiene helped to enhance the toughness of the relatively brittle PMMA (polymethyl methacrylate) matrix that forms from the cross-linking of MMA (methyl methacrylate) monomer. It is believed that the rubber acts to toughen the PMMA matrix by two mechanisms. The first mechanism is that the rubber forms discreet domains of elastomer that precipitates during the cure of MMA monomer into PMMA polymer. The second mechanism is that the conjugated diene bond within the elastomer reacts with the MMA to a minor extent chemically knitting it into the PMMA matrix. The extent of the bonding between the MMA and the conjugated diene is limited by the molecular conformations of the conjugated diene elastomer. The molecular chains of such elastomers are coiled and bent into themselves, thus not favoring the molecular proximity required for good cross-linking between the diene bond and the reactive MMA molecule. For these reasons, the formed materials have properties that only slightly improve the elongation of the primarily PMMA matrix. The improvements might increase failure strains from 2% maximum elongation in the pure PMMA matrix to nearly 10% elongation at failure in PMMA that is toughened using the elastomeric species mentioned. The observed failures seen in such materials do not include the classic “whiting” of the toughened PMMA that is caused by cavitation of the elastomeric domains at the PMMA interface.

Materials have been developed that utilized both the solution grade elastomers previously mentioned in combinations with “core/shell” impact modifiers. The “core/shell” family of elastomers is actually a copolymer particulate that assumes a roughly spherical configuration. A “core” rubber comprises the center of the particle which is polymerized first. Elastomeric reactants are fed into an emulsion polymerization reactor first. As the reaction progresses, the product yielded is an elastomer submicron particle. Its chemical composition may be based on many possible rubber and rubber copolymer types. They may be acrylates such as butyl acrylate or copolymers based elastomers such as styrene butadiene. When the rubber particle grows at its nucleation site to a sufficient size in the emulsion polymerization, the feed stock is changed to reactants forming a hard polymer or copolymer that comprises the shell of the particle. These may be polymers or copolymers such as methyl methacrylate or styrene acrylonitrile. The resulting particle comprises a core of elastomeric species covered by a shell of a harder polymeric species. There is typically a transition zone between the distinct core and shell particle zones that comprises a copolymeric species of the two distinct feed stocks.

Two-part methacrylate adhesives overcome some of the major drawbacks of polyurethane adhesives. They are much more tolerant of unclean or unprepared surfaces, and they have a much more favorable cure profile in terms of open working time and cure rates. In addition, methacrylate adhesives exhibit equal or better affinity for metal and plastic surfaces than polyurethanes. The substrate solvating power of MMA is very useful in developing bonds based on molecular entanglement where urethanes do not have such capabilities. Some materials, in particular certain composite materials with high degrees of chemical resistance, are difficult to bond in the “as received” condition with urethanes.

Recent methacrylate adhesives show significant improvements in many properties, such as greater elasticity, toughness and flexibility. It is believed that methacrylate adhesives using solution grade elastomers act to toughen a PMMA matrix by two means. First the solution grade elastomers are believed to form discreet domains of elastomer that precipitate during the cure of the MMA monomer into the PMMA polymer. Second, when the conjugated diene bond within the elastomer reacts with the MMA monomer, the elastomer and MMA monomer become chemically interlaced into the PMMA matrix. The extent of bonding between the MMA and the conjugated diene elastomer is however limited by the conformations of the conjugated diene elastomer. That is, the molecular chains of such elastomers are coiled and bent into themselves in such a way that molecular proximity between the diene bond and the reactive MMA molecule does not always favor good cross-linking. Cross-linking between elastomer and the monomer is improved with the use of an interpenetrating polymer network (IPN). An IPN is generally a polymer comprising two or more networks which are at least partially interlaced on a molecular scale but not covalently bonded to each other. These two or more networks cannot be separated unless chemical bonds are broken. In several prior art methacrylate adhesives, the addition of an impact modifier has been used to form the IPN in the adhesive. Non-limiting examples of various types of methacrylate adhesives are disclosed in U.S. Pat. Nos. 3,890,407; 4,112,013; 4,118,436; 4,126, 504; 4,127,699; 4,182,644; 4,223,115; 4,426,243; 4,226,954; 4,263,419; 4,293,655; 4,536,546; 4,714,730; 4,942,201; 5,112,691; 5,206,288; 5,656,345; 5,945,461; 6,462,126; 6,512,043; 6,602,958; 6,730,411; 6,852,801; 6,869,497; and 6,949,602, all of which are incorporated herein by reference. However, not all of the methacrylate adhesives exhibit the improved properties of elasticity, toughness and flexibility initially. Many methacrylate adhesives fail to retain these advantageous properties over a long period of time or when heated to elevated temperatures. The loss of elasticity that occurs in polyurethane or methacrylate adhesives, upon a brief exposure at elevated temperatures, may be the result of a continuation of the curing process, or a “post curing” process. It is also believed that certain physical changes in the phase distribution of glassy and rubbery components or domains can occur in the cured composition when it is heated to or above its glass transition temperature. The loss of elasticity that occurs upon prolonged exposure to elevated temperatures can also be the result of either the post curing or physical processes described above, or chemical degradation because of oxidative or other thermally induced reactions that adversely affect the polymer structure.

Those methacrylate adhesive systems that are toughened using elastomeric species based on butadiene or other conjugated dienes also have a tendency to exhibit low tolerance to ozone exposure. There continues to be a need to improve the resistance of methacrylate adhesives to ozone exposure.

It is clear from the current state of the art of adhesives, there is a need for an adhesive that will reliably and predictably bond to a wide variety of composite surfaces in the “as received” condition, and rapidly bond to the composite surface and without the application of heat to complete the cure and/or develop full adhesive bond strength. There is also a need for an adhesive that will bond with a wide variety of structural materials such as metal, thermoplastics, wood, etc. There is further a need for an adhesive to possess a high and predictable degree of elasticity and to retain its elasticity when exposed to elevated temperatures during the curing process and/or in service.

### SUMMARY OF THE INVENTION

The present invention is directed to an adhesive that addresses the problems set forth above. The adhesive of the present invention includes acrylate and/or methacrylate monomer, urethane elastomer and impact modifier. The adhesive technology of the present invention can be used in both 10:1 and 1:1 type adhesives. The adhesive of the present invention can be at least partially based on a polymethyl methacrylate (PMMA) matrix that forms from the cross-linking of methyl methacrylate monomer (MMA). The adhesive of the present invention can be formulated to reduce the rate at which the adhesive cures so as to reduce curing temperatures that may adversely affect the adhesive and/or the materials the adhesive is bonding to and/or to enable components to be positioned relative to one another prior to complete or substantially complete curing of the adhesive on such components; however, this is not required. The adhesive of the present invention is also formulated to adhere to a wide variety of surfaces. Indeed, the adhesive of the present invention can be formulated to form strong bonds with surfaces that traditionally only urethane adhesives or methacrylate adhesives could form strong bonds. The adhesive of the present invention is also formulated to have improved elasticity as compared with prior methacrylate adhesives.

The adhesive of the present invention is directed to a novel combination of acrylate and/or methacrylate monomer, impact modifier and elastomer that includes urethane and/or forms urethane during the curing of the adhesive. The combination of these three components to form an adhesive is believed novel in the art of adhesives.

The one or more acrylate and/or methacrylate monomers that are used in the adhesive of the present invention include an acrylate-based and/or methacrylate-based material, such as an ester monomer. Such reactants are generally the reaction products of acrylic and/or methacrylic acids with one or more mono- or polybasic, substituted or unsubstituted, alkyl (C₁-C₂₀), aryl, aralkyl, and/or heterocyclic alcohols. The ester monomers, when used, can be alkyl monomers (e.g., C₁-C₄, etc.). In one non-limiting embodiment of the invention, the methacrylate ester monomers have an alcohol portion of the ester group that contains 1-12 carbon atoms, and more typically 1-8 carbons. Other monomers that can be used in combination with the methacrylate monomers are acrylate esters wherein the alcohol portion of the ester contains 1-8 carbon atoms (e.g., methyl acrylate, ethyl acrylate, butyl acrylate and 2-ethyhexyl acrylate, etc.), acrylonitrile, methacrylonitrile, styrene, and/or vinyl toluene; however, this is not required. Acrylic and/or methacrylic monomers that can be used in the present invention include, but are not limited to, methyl methacrylate, ethyl methacrylate, methyl acrylate, ethyl acrylate, butyl methacrylate, cyclohexyl methacrylate, hexyl methacrylate, 2-ethylhexyl methacrylate, tetrahydrofurfuryl methacrylate, lauryl methacrylate, butyl acrylate, cyclohexyl acrylate, hexyl acrylate, 2-ethylhexyl acrylate, lauryl acrylate, methacrylic acid, acrylic acid, ethylene glycol, higher-glycol acrylates, diacrylates, methacrylates and/or dimethacrylates. These and other acrylic and/or methacrylic monomers that can be used in the present invention are disclosed in U.S. Pat. Nos. 4,942,201; 5,656,345; 5,945,461; 6,462,126; 6,602,958; 6,730,411; and 6,949,602, all of which are incorporated herein by reference. The content of the acrylate and/or methacrylate monomers in the adhesive of the present invention is generally more than 50 weight percent of the adhesive and up to about 90 weight percent of the mixture, typically about 51-75 weight percent of the adhesive, more typically about 55-70 weight percent of the adhesive, and even more typically about 60-65 weight percent of the adhesive.

The adhesive includes one or more elastomers that include urethane and/or form urethane during the curing of the adhesive. One or more of the elastomers can be at least partially soluble in the acrylate and/or methacrylate monomers that are used in the adhesive; however, this is not required. In one non-limiting embodiment of the invention, the elastomer includes urethane rubber (thermoplastic urethane elastomer). It has been found that when the elastomer includes urethane rubber and/or forms urethane rubber during the curing of the adhesive, a high elongation IPN forms during the curing of the adhesive which results in enhanced adhesion of the adhesive mixture to a variety of materials such as, but not limited to urethane resins and blends thereof, DCPD resins, DCPD polyester resins, blends of DCPD resins and DCPD polyester resins, iso and/or ortho acid-based polyesters, vinyl ester type resins, and/or fiber reinforced composites utilizing the aforementioned resins. One non-limiting urethane rubber that can be used in the adhesive includes polyether polyurethane. In one non-limiting aspect of this embodiment, urethane rubber has a Tg (glass transition temperature) at or below about 0° C. In still another and/or alternative non-limiting aspect of this embodiment, the urethane rubber includes urethane pre-polymers and/or polyols that can be polymerized to foi in polyurethane rubber (e.g., peroxide cure, etc.) during the curing of the adhesive. In yet another and/or alternative non-limiting aspect of this embodiment, the urethane rubber has a molecular weight of at least 2000 Mn (number average molecular weight) and/or at least 2000 repeating units of polymer. In still yet another and/or alternative non-limiting aspect of this embodiment, the elastomer includes at least about 1 weight percent urethane rubber and/or urethane pre-polymers and/or polyols that form polyurethane rubber. In one non-limiting aspect of this embodiment, the elastomer includes at least about 5 weight percent urethane rubber and/or urethane pre-polymers and/or polyols that form polyurethane rubber. In another non-limiting aspect of this embodiment, the elastomer includes at least about 10 weight percent urethane rubber and/or urethane pre-polymers and/or polyols that form polyurethane rubber. In another non-limiting aspect of this embodiment, the elastomer includes at least about 25 weight percent urethane rubber and/or urethane pre-polymers and/or polyols that form polyurethane rubber. In another non-limiting aspect of this embodiment, the elastomer includes at least about 40 weight percent urethane rubber and/or urethane pre-polymers and/or polyols that foi in polyurethane rubber. In another non-limiting aspect of this embodiment, the elastomer includes a majority weight percent urethane rubber and/or urethane pre-polymers and/or polyols that form polyurethane rubber. In another non-limiting aspect of this embodiment, the elastomer includes at least about 60 weight percent urethane rubber and/or urethane pre-polymers and/or polyols that form polyurethane rubber. In another non-limiting aspect of this embodiment, the elastomer includes at least about 75 weight percent urethane rubber and/or urethane pre-polymers and/or polyols that form polyurethane rubber. In another non-limiting aspect of this embodiment, the elastomer includes at least about 90 weight percent urethane rubber and/or urethane pre-polymers and/or polyols that foi in polyurethane rubber. In another non-limiting aspect of this embodiment, the elastomer only includes urethane rubber and/or urethane pre-polymers and/or polyols that form polyurethane rubber. When the elastomer is not fully formed of urethane rubber and/or urethane pre-polymers and/or polyols that form polyurethane rubber, the elastomer can include one or more secondary elastomers. Such secondary elastomers can include, but are not limited to, a) polychloroprene and/or copolymers of butadiene and/or isoprene with styrene, acrylonitrile, acrylate esters, and/or methacrylate esters, b) copolymers of ethylene and/or acrylate esters, c) homopolymers of epichlorohydrin, d) copolymers of epichlorohydrin and/or ethylene, and/or e) urethane rubber. Non-limiting examples of elastomers that can be used in the adhesive composition include ABR (Acrylate Butadiene), BR (Polybutadiene), CO-ECO (Homopolymer of epichlorohydrin, copolymer of epichlorohydrin with ethylene oxide), COX (Butadiene-Acrylonitrile modified with carboxylic groups), CR (Polychloroprene), CSM (Chlorosulfonated Polyethylene), EPM & EPDM (Ethylene-Propylene copolymer, Terpolymer of ethylene and propylene and a diene side chain), FPM (Copolymer of vinlyidene fluoride and hexafluoropropylene, copolymer of chlorotrifluoroethylene and vinylidene fluoride), IR (Polyisoprene, Synthetic Isoprene rubber), IIR (Isobutylene-isoprene copolymer), NBR (Butadiene-acrylonitrile copolymer), NR (Polyisoprene plus resins, Natural isoprene), NBR (Butadiene-Acrylonitrile Copolymer), PVC-NBR (Blend of polyvinyl chloride and NBR), SBR elastomers (Styrene-Butadiene Rubber), SBS (Styrene-Butadiene-Styrene), T (Organic polysulfide), and/or copolymers of ethylene and acrylate esters. A more detail description of several of these elastomers is described in the “Handbook of Plastics and Elastomers” pages 1-106-119, (1975) McGraw-Hill, Inc., which is hereby incorporated by reference. Non-limiting examples of secondary elastomers that can be used in the adhesive of the present invention are disclosed in U.S. Pat. Nos. 4,942,201; 5,656,345; 5,945,461; 6,462,126; 6,602,958; 6,730,411; and 6,949,602, all of which are incorporated herein by reference. The content of the elastomers in the adhesive of the present invention is at least about 0.1 weight percent of the adhesive and up to about 15 weight percent of the adhesive, typically about 0.5-10 weight percent of the adhesive, more typically about 1-8 weight percent of the adhesive, even more typically about 2-5 weight percent of the adhesive, and still even more typically about 2 weight percent to less than 5 weight percent.

The adhesive includes one or more impact modifiers to improve cross-linking in the adhesive and/or to achieve an adhesive having improved elongation properties. The impact modifiers are generally core-shell elastomers that include a copolymer particle that assumes a roughly spherical configuration. The center of this particle has a rubber/elastomeric “core” which is polymerized during the curing of the adhesive; however, this is not required. The rubber/elastomeric “core” is generally formed as elastomeric reactants are first added into an emulsion polymerization reaction; however, this is not required. As the reaction progresses, an elastomeric submicron particle can be produced. The chemical composition of this rubber /elastomeric “core” particle may be based on a multitude of rubber and rubber copolymer types including acrylates or copolymer-based elastomers such as, but not limited to, styrene, butadiene, etc. When the rubber /elastomeric “core” particle grows at its nucleation site to a sufficient size in the emulsion polymerization, the feed stock can be changed to reactants forming a hard polymer or copolymer “shell.” Non-limiting examples of impact modifiers that can be used in the present invention include, but are not limited to, MMA, MBS, styrene acrylonitrile, butadiene, ethyl acrylate, butyl acrylate, ethyl acrylate, isobutyl acrylate, 2-ethylhexyl acrylate, styrene, vinyl acetate, methyl methacrylate, butadiene, isoprene, ethylene glycol diacrylate, butylene glycol dimethacrylate, diallyl maleate, allyl methacrylate. Several of these and other impact modifiers that can be used in the adhesive of the present invention are disclosed in U.S. Pat. Nos. 3,944,631; 3,984,497; 3,985,703; 4,096,202; 4,034,013; 4,304,709; 4,306,040; 4,495,324; 4,942,201; 5,945,461; 6,462,126; 6,602,958; 6,730,411; and 6,949,602, all of which are incorporated herein by reference. The resulting rubber/elastomeric “core” particle generally includes a core of an elastomeric species and a shell of a harder polymeric species. With this type of particle, there typically is a transition zone between the core and shell that is comprised of a copolymeric species of the two distinct feed stocks. The use of core-shell impact modifiers have been previously disclosed in several prior art adhesives to improve various physical properties of the adhesive; however, these core-shell impact modifiers are disclosed as only being swelled within the MMA monomer, but do not dissolve in it, thus the MMA monomer of these prior art adhesives only permeates and wets the core of the impact modifier. It is believed that this phenomena is due to the fact that most impact modifiers disclosed in prior art adhesives comprise “core” elastomers with no unsaturation, very low reactivity in the rubber type and/or very low levels of unsaturation. It is believed that the “core” rubber in the impact modifier needs to enable cross-linking between the primary cured PMMA matrix and the “core” rubber. It is also believed that the “core” rubber needs to possess a balance of strength and elongation as well as reactivity to yield the desired toughening mechanism. For instance, impact modifiers that use butyl acrylate as a “core” elastomer may possess high elongation but very low strength. When stress is applied to the interface, the core rubber fails at a very low stress, thus not enabling high strength or elongation formulations for the adhesive. In one non-limiting embodiment of the present invention, the impact modifier includes methacrylate-butadiene-styrene copolymer (MBS). In one non-limiting aspect of this embodiment, at least about 5 weight percent of the impact modifier includes MBS. In another non-limiting aspect of this embodiment, at least about 10 weight percent of the impact modifier includes MBS. In another non-limiting aspect of this embodiment, at least about 25 weight percent of the impact modifier includes MBS. In another non-limiting aspect of this embodiment, at least about 40 weight percent of the impact modifier includes MBS. In another non-limiting aspect of this embodiment, at least a majority weight percent of the impact modifier includes MBS. In another non-limiting aspect of this embodiment, at least about 60 weight percent of the impact modifier includes MBS. In another non-limiting aspect of this embodiment, at least about 75 weight percent of the impact modifier includes MBS. In another non-limiting aspect of this embodiment, at least about 90 weight percent of the impact modifier includes MBS. In another non-limiting aspect of this embodiment, all of the impact modifier is MBS. It has been found that impact modifiers comprising methacrylate-butadiene-styrene copolymer (MBS) in combination with certain types of acrylate and/or methacrylate monomers and polymer elastomers yield high elongation adhesive mixtures that are capable of elongation levels at failure of more than 20% elongation and can be as high as 250% elongation or more. The elongation at failure for the adhesive is typically greater than about 45%, more typically greater than about 50%, even more typically greater than about 60%, and still even more typically about 75-250%. The content of the impact modifier in the adhesive composition of the present invention is at least about 0.01 weight percent of the adhesive mixture and up to about 25 weight percent of the adhesive mixture, typically about 1-22 weight percent of the adhesive mixture, more typically about 2-20 weight percent of the adhesive mixture, and even more typically about 5-17 weight percent of the adhesive mixture.

The weight percent ratio of the three primary components of the adhesive of the present invention are believed to be important to achieve the desired elongation levels of the adhesive, the desired bonding properties of the adhesive, and/or the desired curing rate of the adhesive. In one non-limiting embodiment of the invention, the weight percent of the acrylate and/or methacrylate monomers in the adhesive is greater than the combined weight percentages of elastomer and impact modifier in the adhesive. In one non-limiting aspect of this embodiment, the weight ratio in the adhesive of acrylate and/or methacrylate monomers in the adhesive to the combined content of elastomer and impact modifier in the adhesive is about 1.01-100:1. In another non-limiting aspect of this embodiment, the weight ratio of acrylate and/or methacrylate monomers in the adhesive to the combined content of elastomer and impact modifier in the adhesive is about 1.15-50:1. In still another non-limiting aspect of this embodiment, the weight ratio of acrylate and/or methacrylate monomers in the adhesive to the combined content of elastomer and impact modifier in the adhesive is about 1.2-20:1. In yet another non-limiting aspect of this embodiment, the weight ratio of acrylate and/or methacrylate monomers in the adhesive to the combined content of elastomer and impact modifier in the adhesive is about 1.5-15:1. In still yet another non-limiting aspect of this embodiment, the weight ratio of acrylate and/or methacrylate monomers in the adhesive to the combined content of elastomer and impact modifier in the adhesive is about 2-12:1. In a further non-limiting aspect of this embodiment, the weight ratio of acrylate and/or methacrylate monomers in the adhesive to the combined content of elastomer and impact modifier in the adhesive is about 2.2-10:1. In still a further non-limiting aspect of this embodiment, the weight ratio of acrylate and/or methacrylate monomers in the adhesive to the combined content of elastomer and impact modifier in the adhesive is about 2.5-9.5:1. In still yet a further non-limiting aspect of this embodiment, the weight ratio of acrylate and/or methacrylate monomers in the adhesive to the combined content of elastomer and impact modifier in the adhesive is about 2.6-5:1. In another non-limiting aspect of this embodiment, the weight ratio of acrylate and/or methacrylate monomers in the adhesive to the combined content of elastomer and impact modifier in the adhesive is about 2.8-4:1. In still another non-limiting aspect of this embodiment, the weight ratio of acrylate and/or methacrylate monomers in the adhesive to the combined content of elastomer and impact modifier in the adhesive is about 2.9-3.8:1. In another non-limiting embodiment of the invention, the weight percent of the acrylate and/or methacrylate monomers in the adhesive is greater than the weight percent of elastomer in the adhesive. In one non-limiting aspect of this embodiment, the weight ratio of acrylate and/or methacrylate monomers in the adhesive to the elastomer in the adhesive is about 2-250:1. In another non-limiting aspect of this embodiment, the weight ratio of acrylate and/or methacrylate monomers in the adhesive to the elastomer in the adhesive is about 3-150:1. In another non-limiting aspect of this embodiment, the weight ratio of acrylate and/or methacrylate monomers in the adhesive to the elastomer in the adhesive is about 3-150:1. In still another non-limiting aspect of this embodiment, the weight ratio of acrylate and/or methacrylate monomers in the adhesive to the elastomer in the adhesive is about 5-100:1. In yet another non-limiting aspect of this embodiment, the weight ratio of acrylate and/or methacrylate monomers in the adhesive to the elastomer in the adhesive is about 8-75:1. In still yet another non-limiting aspect of this embodiment, the weight ratio of acrylate and/or methacrylate monomers in the adhesive to the elastomer in the adhesive is about 9-50:1. In a further non-limiting aspect of this embodiment, the weight ratio of acrylate and/or methacrylate monomers in the adhesive to the elastomer in the adhesive is about 10-40:1. In still a further non-limiting aspect of this embodiment, the weight ratio of acrylate and/or methacrylate monomers in the adhesive to the elastomer in the adhesive is about 12-34:1. In yet a further non-limiting aspect of this embodiment, the weight ratio of acrylate and/or methacrylate monomers in the adhesive to the elastomer in the adhesive is about 14-25:1. In still yet a further non-limiting aspect of this embodiment, the weight ratio of acrylate and/or methacrylate monomers in the adhesive to the elastomer in the adhesive is about 15-23:1. In another non-limiting aspect of this embodiment, the weight ratio of acrylate and/or methacrylate monomers in the adhesive to the elastomer in the adhesive is about 16-22:1. In still another non-limiting embodiment of the invention, the weight percent of acrylate and/or methacrylate monomers in the adhesive is greater than the weight percent of impact modifier in the adhesive. In one non-limiting aspect of this embodiment, the weight ratio of acrylate and/or methacrylate monomers in the adhesive to the impact modifier in the adhesive is about 2-200:1. In another non-limiting aspect of this embodiment, the weight ratio of acrylate and/or methacrylate monomers in the adhesive to the impact modifier in the adhesive is about 2.2-100:1. In still another non-limiting aspect of this embodiment, the weight ratio of acrylate and/or methacrylate monomers in the adhesive to the impact modifier in the adhesive is about 2.5-50:1. In yet another non-limiting aspect of this embodiment, the weight ratio of acrylate and/or methacrylate monomers in the adhesive to the impact modifier in the adhesive is about 2.8-30:1. In still yet another non-limiting aspect of this embodiment, the weight ratio of acrylate and/or methacrylate monomers in the adhesive to the impact modifier in the adhesive is about 3-20:1. In a further non-limiting aspect of this embodiment, the weight ratio of acrylate and/or methacrylate monomers in the adhesive to the impact modifier in the adhesive is about 3.2-18:1. In still a further non-limiting aspect of this embodiment, the weight ratio of acrylate and/or methacrylate monomers in the adhesive to the impact modifier in the adhesive is about 3.3-14:1. In yet a further non-limiting aspect of this embodiment, the weight ratio of acrylate and/or methacrylate monomers in the adhesive to the impact modifier in the adhesive is about 3.4-10:1. In still yet a further non-limiting aspect of this embodiment, the weight ratio of acrylate and/or methacrylate monomers in the adhesive to the impact modifier in the adhesive is about 3.5-6:1. In another non-limiting aspect of this embodiment, the weight ratio of acrylate and/or methacrylate monomers in the adhesive to the impact modifier in the adhesive is about 3.6-4.8:1. In still yet another non-limiting embodiment of the invention, the weight percent of impact modifier in the adhesive is greater than the weight percent of elastomer in the adhesive. In one non-limiting aspect of this embodiment, the weight ratio of impact modifier in the adhesive to elastomer in the adhesive is about 1.01-100:1. In another non-limiting aspect of this embodiment, the weight ratio of impact modifier in the adhesive to elastomer in the adhesive is about 1.01-50:1. In still another non-limiting aspect of this embodiment, the weight ratio of impact modifier in the adhesive to elastomer in the adhesive is about 1.01-20:1. In yet another non-limiting aspect of this embodiment, the weight ratio of impact modifier in the adhesive to elastomer in the adhesive is about 1.05-15:1. In still another non-limiting aspect of this embodiment, the weight ratio of impact modifier in the adhesive to elastomer in the adhesive is about 1.05-10:1. In still yet another non-limiting aspect of this embodiment, the weight ratio of impact modifier in the adhesive to elastomer in the adhesive is about 1.1-9:1. In a further non-limiting aspect of this embodiment, the weight ratio of impact modifier in the adhesive to elastomer in the adhesive is about 1.1-8.5:1. In still a further non-limiting aspect of this embodiment, the weight ratio of impact modifier in the adhesive to elastomer in the adhesive is about 2-8:1. In yet a further non-limiting aspect of this embodiment, the weight ratio of impact modifier in the adhesive to elastomer in the adhesive is about 3-7:1. In still yet a further non-limiting aspect of this embodiment, the weight ratio of impact modifier in the adhesive to elastomer in the adhesive is about 3.4-6.5:1.

At least a portion of the impact modifier of the present invention can be formulated to at least partially absorb an MMA monomer, which contributes to a gel or paste-like rheology in the adhesive; however, this is not required. It is believed that prior to mixing the impact modifier in the one or more acrylate and/or methacrylate monomers, the elastomer that is previously mixed with the MMA is contorted and conformed into many tightly coiled configurations, thus not allowing the required molecular proximity of its reactive double bonds to cross-link effectively with the MMA monomer and/or the elastomer. In fact, the solubility parameter of the monomer is believed to be important towards the end of the elastomer uncoiling itself to enable this effect. In one non-limiting embodiment of the invention, the impact modifier of the present invention is selected so that a majority of the impact modifier dissolves and/or absorbs in the acrylate and/or methacrylate monomers; however, this is not required. In one aspect of this embodiment, the impact modifier of the present invention is selected so that at least about 60% of the impact modifier dissolves in and/or absorbs the acrylate and/or methacrylate monomers, more typically at least about 75% of the impact modifier dissolves in and/or absorbs the acrylate and/or methacrylate monomers, even typically at least about 80% of the impact modifier dissolves in and/or absorbs the acrylate and/or methacrylate monomers, still more typically at least about 85% of the impact modifier dissolves in and/or absorbs the acrylate and/or methacrylate monomers, and still even more typically at least about 95% of the impact modifier dissolves in and/or absorbs the acrylate and/or methacrylate monomers. It is believed that the shearing process used to combine the elastomer and the impact modifier with the acrylate and/or methacrylate monomers enable the uncoiling of the elastomer to occur. It is believed that effective uncoiling at least partially occurs by high energy shearing action and remains in such a state due to the rheology created by the presence of the impact modifier particle. It is believed that the elastomer is whipped into a flow oriented relatively straight and uncoiled chain through shearing action. The uncoiled configuration of the elastomer is preserved through its suspension in the gel rheology of the adhesive resulting at least in part from the swelling of the impact modifier. MMA, elastomer and impact modifier can be selected so that the MMA can be formulated to react with the elastomer and/or impact modifier at room temperature, thereby knitting together the uncoiled elastomer with the impact modifier; however, this is not required. The resulting adhesive is believed to comprise a predominantly PMMA matrix that is intertwined with the elastomeric species of the impact modifier and elastomer. The long chains of the elastomer are believed to be relatively straight. The relative volumes of both the molecular chains (strings) of the elastomer and the spherical (balls) of the impact modifier yield a proximity that favors a very tough IPN. The relatively flexible elastomeric components are believed to provide unexpected elongation and energy-absorbing capabilities. The more rigid PMMA matrix is believed to be effectively inter-bonded with the other components in the adhesive. The resulting cured material possesses a combination of the properties of all three primary components of the adhesive (i.e., MMA, elastomer, impact modifier).

The adhesive generally includes a catalyst; however, this is not required. The catalyst is generally a free radical generator that is designed to trigger the polymerization of acrylate and/or methacrylate compounds. Suitable catalysts include, but are not limited to, organic peroxides, organic hydroperoxides, organic peresters, and/or organic peracids. Non-limiting examples of catalysts that can be used include, but are not limited to, benzoyl peroxide, cumene hydroperoxide, acetyl peroxide, tertiary butyl hydroperoxide, lauroyl peroxide, dicumyl peroxide, tertiary butyl peroxide acetate, tertiary butyl perbenzoate, ditertiary butyl azodiisobutyronitrile, and/or methyl ethyl ketone peroxide. The amount of the catalyst used to polymerize the adhesive can be up to about 20 weight percent of the adhesive mixture, typically about 0.01-10 weight percent of the adhesive mixture, more typically about 0.1-6 weight percent of the adhesive mixture, and even more typically about 0.3-4 weight percent of the adhesive mixture. The adhesive composition can include a catalyst activator; however, this is not required. Non-limiting catalyst activators that can be used include, but are not limited to, butyraldehyde, butylamine and/or aniline. These and other catalysts that can be used in the adhesive of the present invention are disclosed in U.S. Pat. Nos. 4,942,201; 5,656,345; 5,945,461; 6,462,126; 6,602,958; 6,730,411; and 6,949,602, all of which are incorporated herein by reference.

The adhesive composition can include an accelerator; however, this is not required. The accelerator, when used, is generally at least about 0.01 weight percent of the adhesive mixture, typically about 0.1-6 weight percent of the adhesive mixture, and more typically about 0.2-4 weight percent of the adhesive mixture. Non-limiting accelerators that can be used include, but are not limited to, tertiary amines (N,N-dimethylaniline, N,N-dimethyltoluidine, N,N-diethylaniline, N,N-diethyltoluidine, etc.) and/or aldehyde-amines (butyraldehyde-aniline, butyraldehyde-butylamine, etc.). Other materials can also or alternatively be added to the adhesive composition to increase the speed of reaction such as, but not limited to, metal salts (e.g., cobalt naphthenate, nickel naphthenate, manganese naphthenate, iron naphthenate, copper octoate, iron hexoate, iron propionate, etc.). These and other accelerators that can be used in the adhesive of the present invention are disclosed in U.S. Pat. Nos. 4,942,201; 5,656,345; 5,945,461; 6,462,126; 6,602,958; 6,730,411; and 6,949,602, all of which are incorporated herein by reference.

The adhesive composition can include one or more other additives such as, but not limited to stabilizers, chain transfer agents, comonomers, adhesion promoters, plasticizers, fillers, thickeners, pigments, UV protectors, wetting agents, colorants, reinforcement fibers, etc.; however, this is not required. Acrylic acid, methacrylic acid, crotonic acid, maleic acid and/or fumaric acid, and other unsaturated carboxylic acids, as well as phosphorus containing acid esters, when used, can function as comonomers and/or adhesion promoters. Such acids, when used, generally constitute at least about 0.1 weight percent of the adhesive, typically about 0.2-7 weight percent of the adhesive, and more typically about 0.5-5 weight percent of the adhesive. The stabilizer, when used, can include phenols and/or quinones to stabilize acrylate and/or methacrylate monomers against premature polymerization during storage. Metal chelators can be used to enhance stabilization by sequestering metal ions that can enhance premature polymerization. Epoxy resins and other acid acceptors can be used to enhance stabilization of compositions whose premature polymerization may be influenced by traces of acidic species. Chain transfer agents, when used, can include mercaptans to polymerizable compositions to regulate the rate of polymerization and control the resulting degree of cross-linking and molecular weight of the polymer. Comonomers, when used, can include styrene, alpha-methyl styrene, vinyl toluene, etc. in combination with acrylate and/or methacrylate monomers to affect the rate of polymerization and the properties of the cured compositions. Organosilanes and phosphorous compounds, including those containing acrylate, methacrylate, and other unsaturated and reactive groups in their structures, when used can function as adhesion promoters. Stabilizers, chain transfer agents, plasticizers, fillers, thickeners, pigments, UV protectors, wetting agents, and/or colorants are commonly used to fog mulate adhesive compositions of all chemical types. Such components can also be used to modify the compositions of the instant compositions. When one or more of these components are included in the adhesive, the total weight percent of such components in the adhesive is at least about 0.1 weight percent of the adhesive and less than about 25 weight percent of the adhesive, typically less than about 10 weight percent of the adhesive, and more typically less than about 8 weight percent of the adhesive.

One non-limiting embodiment of the invention is directed to 10:1 peroxide cured thermoset adhesives and 1:1 polyolefins containing pendent chlorine and sulfonyl chloride groups (e.g., chlorosulfonated polyethylene, etc.)/pyridine based compound (e.g., dihydropyridine, etc.) cured thermoset adhesives that are based on cross-linkable vinyl monomers (e.g., acrylate and/or methacrylate monomers) such as, but not limited to, MMA that incorporate MBS particles and thermoplastic polyurethane elastomer. The thermoplastic polyurethane elastomer is believed to be capable of producing the larger elongation IPN. The thermoplastic polyurethane elastomer is also believed to greatly enhance adhesion of the resulting adhesive to a variety of materials such as, but not limited to, urethane resins and blends thereof, DCPD resins, DCPD polyester resins and all blends thereof containing DCPD, all iso and ortho acid based polyesters and combinations thereof, all vinyl ester type resins and combinations thereof, all fiber reinforced composite utilizing such resins, wood, metals, ceramics, glass and the like. The thermoplastic polyurethane elastomer typically has a Tg at or below about 0° C. The thermoplastic polyurethane elastomer typically has a molecular weight of at least 2000 Mn (number average molecular weight) and/or at least 2000 repeating units of polymer. The thermoplastic polyurethane elastomer used in the adhesive can be added as an already formed polyurethane and/or as urethane pre-polymers and polyols that can be polymerized to form a polyurethane during the curing of the adhesive.

Another non-limiting embodiment of the invention is directed to 10:1 peroxide cured them oset adhesives and 1:1 polyolefins containing pendent chlorine and sulfonyl chloride groups (e.g., chlorosulfonated polyethylene, etc.)/pyridine based compound (e.g., dihydropyridine, etc.) cured thermoset adhesives that are based on cross-linkable vinyl monomers (e.g., acrylate and/or methacrylate monomers) such as, but not limited to, MMA that incorporate MBS particles and rubber material (e.g., Hypalon rubber, etc.) in combination with thermosetting epoxide polymer (e.g., epoxy resins) to enhance certain mechanical properties of the adhesive such as, but not limited to, adhesion to various materials such as metals, epoxy resin-based composites, paints and coatings. The combination of these materials in the adhesive is believed to greatly improve elevated temperature properties of the adhesive such as, but not limited to, strength, toughness and/or adhesion. It has been found that epoxy resins of sufficient molecular weight can unexpectedly be cured using the 1:1 adhesive system. In one non-limiting example it has been found that large quantities of epoxy resin can be incorporated in the cure mechanism of dihydropyridine, Hypalon rubber and CHP (i.e., cumyl/hydroperoxide) in a largely MMA based adhesive. No typical epoxy curatives based on amine, anhydride or boron tri-fluoride are required to generate cross-linking in the adhesive. The radical species developed through the 1:1 cure chemistry appears to cross-link the epoxy with the resulting matrix. The use of epoxy resins of sufficiently high molecular weight can be used to improve the toughness of the 1:1 type adhesives. The combination of both epoxy and polyurethane in the adhesive is capable of producing superb materials in combination with a free radical curing system, methacrylate monomer and MBS impact modifier. Such adhesive combination is also capable of yielding unique and superb materials in combination with the polyolefins containing pendent chlorine and sulfonyl chloride groups/pyridine based compound/peroxide or hydroperoxide cure mechanism and MBS impact modifier. Lower viscosity versions of the formulations can be as matrix resins for tough composite materials and coatings offering thermoplastic type matrix performance in a thermoset system.

Still another non-limiting embodiment of the invention is directed to thermoplastic and/or thermoset prepolymer urethane resins that can be used to retard exotherm development time and suppress peak exothermic temperature in free radical and rubber material (e.g., Hypalon rubber, etc.) cured MMA (or other methacrylate monomer) based adhesives, resins and coatings. In one non-limiting embodiment of the invention, adhesives having a 1:1 ratio cure mechanism can be formulated to control the cure rate and heat generation during the curing of the adhesive. The “A” component of the adhesive can include chlorosulfonated polyethylene elastomer (Hypalon) and cumene hydroperoxide (CHP) catalyst that will not react together in the presence of MMA. The “B” component or “activator” of the adhesive can include dihydro pyridine and a metallic accelerator. The combination of the “A” and “B” components are used to facilitate the cure of the MMA monomer in both the “A” and “B” components of the adhesive. This type of adhesive is different from prior art adhesives in that both the “A” and “B” components include a reactive monomer. It is believed that dihydro pyridine in the “B” component causes the abstraction of a hydrogen atom from the sulfonyl chloride species on the Hypalon rubber chain, thus enabling it to work in conjunction with CHP to enable cross-linking of MMA. CHP usually requires a temperature in excess of 180° F. to yield free radicals during the curing process. It is believed that the sulfonyl radical, created through the hydrogen abstraction of Hypalon by dihydropyridine, creates the CHP radical at room temperature. As such, the “A” component of the system is stable at room temperature since it produces no radicals without thermal decomposition. During this reaction, the MMA monomer is cross-linking with itself and a gaffing reaction is taking place simultaneously with the Hypalon. The reaction of the Hypalon with MMA in this embodiment is similar to the reaction of MMA with the conjugated diene in the previous embodiments set forth above. It is believed that the sulfonyl chloride species on the Hypalon chains facilitate this reaction. Similar to other free radical catalyst systems, by varying the amounts of the cure system chemicals, the cure speed of the adhesive can be controlled. The level of Hypalon, CHP, DHP and metallic accelerator will affect cure speed in the adhesive.

These and other advantages will become apparent from the following description of the invention.

### DETAILED DESCRIPTION OF THE INVENTION

The present invention is directed to a novel adhesive that includes three principal components namely, acrylate and/or methacrylate monomer, urethane elastomer and an impact modifier. The adhesive of the present invention can be formed from either 10:1 and 1:1 type adhesives. The adhesive can be formulated to reduce the rate at which the adhesive cures so as to reduce curing temperatures that may adversely affect the adhesive and/or the materials the adhesive is bonding to and/or to enable components to be positioned relative to one another prior to complete or substantially complete curing of the adhesive on such components; however, this is not required. The adhesive can be formulated to adhere to a wide variety of surfaces so as form strong bonds with surfaces that traditionally only strong bonds were formed with either urethane adhesives or methacrylate adhesives. The adhesive is also formulated to have improved ozone and/or elevated temperature resistance, improved adhesion to substrates manufactured using urethane resins or blends thereof, improved wear resistance and frictional properties as compared with prior methacrylate adhesives.

A general formulation of the novel adhesive in weight percent of the adhesive is as follows:

General Formula A

| Acrylate and/or methacrylate monomer | over 50% and up to 95% |
|---|---|
| Urethane elastomer | 0.01-25% |
| Impact modifier including MBS | 0.01-30% |

General Formula B

| Acrylate and/or methacrylate monomer | more than 50% and up to 90% |
|---|---|
| Urethane elastomer | 0.1-15% |
| Impact modifier including MBS | 0.01-25% |

In the general formulations above, the source of the urethane elastomer can come from a preformed urethane elastomer and/or from urethane pre-polymers and polyols that are polymerized to a polyurethane during the curing of the adhesive. The percentage of the urethane elastomer is the amount of urethane elastomer in the adhesive after the adhesive is substantially cured (e.g., at least 95% cured).

The impact modifier used in the adhesive includes methacrylate-butadiene-styrene copolymer (MBS). Typically the impact modifier includes at least about 30 weight percent MBS; however, other weight percentages can be used.

The acrylate and/or methacrylate monomer used in the adhesive typically includes methyl methacrylate monomer (MMA). Typically at least about 20 weight percent of the acrylate and/or methacrylate monomer includes MMA; however, other weight percentages can be used.

Several further examples of formulations of the adhesive of the present invention in weight percent are set forth as follows:

### Example 1

| | |
|---|---|
| Acrylate and/or methacrylate monomer | 55-80% |
| including MMA | |
| Urethane elastomer | 0.5-10% |
| Impact modifier including MBS | 0.5-20% |
| Secondary monomers | 0-10% |
| Epoxy resin | 0-40% |
| Plasticizer | 0-8% |
| Catalyst | 0-20% |
| UV absorber | 0-2% |
| Wetting agent | 0-2% |
| Other additives | 0-15% |
| % elongation prior to failure | over 40% |

### Example 2

| | |
|---|---|
| Acrylate and/or methacrylate monomer | 55-75% |
| including MMA | |
| Urethane elastomer | 1-8% |
| Impact modifier including MBS | 2-20% |
| Secondary monomers | 0-8% |
| Epoxy resin | 0-30% |
| Plasticizer | 0-5% |
| Catalyst | 0-10% |
| UV absorber | 0-1% |
| Wetting agent | 0-1% |
| Other additives | 0-10% |
| % elongation prior to failure | over 50% |

### Example 3

| | |
|---|---|
| Acrylate and/or methacrylate monomer | 60-70% |
| including MMA | |
| Urethane elastomer | 2-7% |
| Impact modifier including | 5-18% |
| at least 5% MBS | |
| Secondary monomers | 0-8% |
| Epoxy resin | 0-30% |
| Plasticizer | 0-5% |
| Catalyst | 0-10% |
| UV absorber | 0-1% |
| Wetting agent | 0-1% |
| Other additives | 0-10% |
| % elongation prior to failure | over 75% |

### Example 4

| | |
|---|---|
| Acrylate and/or methacrylate monomer | 60-68% |
| including MMA | |
| Urethane elastomer including | 2-6% |
| at least 25% urethane rubber | |
| and/or urethane pre-polymers | |
| and/or polyols | |
| Impact modifier including | 5-17% |
| at least 10% MBS | |
| Secondary monomers | 0-5% |
| Epoxy resin | 0-20% |
| Plasticizer | 0-4% |
| Catalyst | 0.01-10% |
| UV absorber | 0-1% |
| Wetting agent | 0-1% |
| Other additives | 0-8% |
| % elongation prior to failure | over 50% |

### Example 5

| | |
|---|---|
| Acrylate and/or methacrylate monomer | 60-68% |
| including MMA | |
| Urethane elastomer including | 2% up to less than 5% |
| at least 25% urethane rubber | |
| and/or urethane pre-polymers | |
| and/or polyols | |
| Impact modifier including | 5-15% |
| at least 10% MBS | |
| Secondary monomers | 0-5% |
| Epoxy resin | 0-20% |
| Plasticizer | 0-4% |
| Catalyst | 0.01-10% |
| UV absorber | 0-1% |
| Wetting agent | 0-1% |
| Other additives | 0-8% |
| % elongation prior to failure | over 80% |

### Example 6

| | |
|---|---|
| Acrylate and/or methacrylate monomer | 60-68% |
| including MMA | |
| Urethane elastomer including | 2-6% |
| at least 25% urethane rubber | |
| and/or urethane pre-polymers | |
| and/or polyols | |
| Impact modifier including | 5% to less than 10% |
| at least 10% MBS | |
| Secondary monomers | 0-5% |
| Epoxy resin | 0-20% |
| Plasticizer | 0-4% |
| Catalyst | 0.01-10% |
| UV absorber | 0-1% |
| Wetting agent | 0-1% |
| Other additives | 0-8% |
| % elongation prior to failure | over 80% |

### Example 7

PART A

| | |
|---|---|
| MMA Monomer | 50-75% |
| Impact modifier including | 0.5-20% |
| at least 20% MBS | |
| Secondary monomers | 0-10% |
| Polyether Prepolymer | 0-12% |
| Hypalon 30 Rubber | 0-20% |
| Plasticizer | 0-8% |
| Hydroperoxide | 0-2% |
| UV absorber | 0-2% |
| Wetting agent | 0-2% |
| Other additives | 0-15% |

PART B

| | |
|---|---|
| MMA Monomer | 50-75% |
| Impact modifier including | 0.5-20% |
| at least 20% MBS | |
| Secondary monomers | 0-10% |
| Tertiary amine curing agent | 0-6% |
| Copper Acetylacetonate | 0-0.05% |
| Phenyl Di Hydro Pyridine | 0-5% |
| Plasticizer | 0-8% |
| Other additives | 0-15% |

The other additives set forth in the examples above can include, but are not limited to, accelerators, adhesion promoters, catalyst activators, chain transfer agents, colorants, comonomers, fillers, pigments, stabilizers, thickeners, etc.

Two specific types of adhesives that are covered by the examples set forth above are 10:1 peroxide cured thermosets and 1:1 Hypalon/Dihydropyridine cured thermosets. Both of these types of adhesives are based on cross-linkable vinyl monomers such as MMA that incorporate the MBS impact modifier and a thermoplastic polyurethane elastomer. One non-limiting thermoplastic polyurethane elastomer that can be used is available commercially as MILLATHANE E34 by TSE Industries. The thermoplastic polyurethane elastomer used in the adhesive of the present invention generally has a Tg at or below about 0° C. As mentioned above, the thermoplastic polyurethane elastomer used in the adhesive can be at least partially formed from urethane pre-polymers that are at least partially polymerized to a polyurethane (e.g., tertiary amine cure) during the curing of the adhesive. The thermoplastic polyurethane elastomer used in the adhesive of the present invention generally has a molecular weight of at least 2000 Mn and/or at least 2000 repeating units of polymer. The thermoplastic and thermoset prepolymer urethane resins, when used in the adhesive, can be used to retard the exotherm development time during the curing of the adhesive and/or to suppress peak exothermic temperatures in free radically and Hypalon cured MMA (or other methacrylate monomer) based adhesives, resins and coatings; however, this is not required.

The examples of the present invention set forth above also cover 10:1 cure chemistry and 1:1 adhesive cure chemistry based adhesives, resins and coatings using the combination of MMA, MBS impact modifier, polyurethane rubber and Hypalon rubber in conjunction with epoxy resins. The inclusion of epoxy resin in the adhesive can be used to enhance certain mechanical properties of the adhesive such as, but not limited to, adhesion of the adhesive to metals, epoxy resin based composites, paints and coatings.

It has been unexpectedly found that epoxy resins can be cured using the 1:1 cure mechanism of dihydropyridine, Hypalon rubber and CHP in a largely MMA based adhesive. The level of epoxy resin incorporation can be quite high. No typical epoxy curatives based on amine, anhydride or boron tri- fluoride are required to generate the cross-linking in the adhesive. The radical species developed through the 1:1 cure chemistry appear to cross-link the epoxy resin with the resulting matrix. This result is very unexpected. The use of epoxy resins of sufficiently high molecular weight 2000 Mn can also be used to improve the toughness of the 1:1 type formulations beyond the values obtained without it. The combination of both epoxy resin and polyurethane in an adhesive are capable of producing a superb adhesive with a free radical curing system that includes methacrylate monomer and MBS impact modifier. In addition, superb adhesives can also be formed from using epoxy resin and polyurethane in combination with a Hypalon/Dihydropyridine/CHP cure mechanism and MBS impact modifier. Lower viscosity versions of the adhesive formulation can be used as matrix resins for tough composite materials and coatings offering thermoplastic type matrix performance in a thermoset system. Fiber reinforced composites generally require a resin matrix. These formulations can be used as such when in a low viscosity form. To get this kind of matrix toughness in a composite usually requires using a thermoplastic matrix. Most thermosets are too rigid having strain to failure levels in the 1-5% range. Polyurethane resins do not bond well to existing fiber surface chemistries. Acrylics do and are capable of approaching the high elongation ranges possible with polyurethanes and some thermoplastic systems (5-20% at failure yielding composites that are significantly tougher than most other thermosetting resin matrices and still bond very well to reinforcement surfaces).

The adhesive of the present invention includes a combination of materials that can be used to greatly improve elevated temperature properties of the cured adhesive such as, but not limited to, strength, toughness and/or adhesion of the adhesive.

It will thus be seen that the objects set forth above, among those made apparent from the preceding description, are efficiently attained, and since certain changes may be made in the constructions set forth without departing from the spirit and scope of the invention, it is intended that all matter contained in the above description and shown in the accompanying drawings shall be interpreted as illustrative and not in a limiting sense. The invention has been described with reference to preferred and alternate embodiments. Modifications and alterations will become apparent to those skilled in the art upon reading and understanding the detailed discussion of the invention provided herein. This invention is intended to include all such modifications and alterations insofar as they come within the scope of the present invention. It is also to be understood that the following claims are intended to cover all of the generic and specific features of the invention herein described and all statements of the scope of the invention, which, as a matter of language, might be said to fall therebetween.

I claim:

1. An adhesive composition comprising over 50 weight percent up to about 95 weight percent acrylic based monomer, methacrylic ester based monomer, and mixtures thereof; 0.01-30 weight percent impact modifier; and about 0.01-25 weight percent elastomer, said elastomer including urethane elastomer, said impact modifier including methacrylate-butadiene-styrene copolymer, said adhesive composition having an elongation at failure that is greater than about 45%.

2. The adhesive composition as defined in claim 1, wherein a majority weight percent of said acrylic based monomer, methacrylic ester based monomer, and mixtures thereof includes methyl methacrylate monomer.

3. The adhesive composition as defined in claim 1, wherein a majority weight percent of said impact modifier includes a methacrylate-butadiene-styrene copolymer.

4. The adhesive composition as defined in claim 2, wherein a majority weight percent of said impact modifier includes a methacrylate-butadiene-styrene copolymer.

5. The adhesive composition as defined in claim 1, wherein a majority weight percent of said elastomer includes urethane elastomer.

6. The adhesive composition as defined in claim 4, wherein a majority weight percent of said elastomer includes urethane elastomer.

7. The adhesive composition as defined in claim 1, wherein said elastomer constitutes less than 5 weight percent of said adhesive composition.

8. The adhesive composition as defined in claim 1, wherein said impact modifier constitutes less than 10 weight percent of said adhesive composition.

9. The adhesive composition as defined in claim 7, wherein said impact modifier constitutes less than 10 weight percent of said adhesive composition.

10. The adhesive composition as defined in claim 1, wherein said urethane elastomer has a Tg at or below about 0° C. and has at least 2000 repeating units of polymer, a molecular weight of at least 2000 Mn, and combinations thereof.

11. The adhesive composition as defined in claim 6, wherein said urethane elastomer has a Tg at or below about 0° C. and has at least 2000 repeating units of polymer, a molecular weight of at least 2000 Mn, and combinations thereof.

12. The adhesive composition as defined in claim 1, including catalyst, said catalyst including organic peroxides, organic hydroperoxides, dihydropyridine, and combinations thereof.

13. The adhesive composition as defined in claim 11, including catalyst, said catalyst including organic peroxides, organic hydroperoxides, dihydropyridine, and combinations thereof.

14. The adhesive composition as defined in claim 1, wherein said impact modifier and said acrylic based monomer, methacrylic ester based monomer, and mixtures thereof are selected so that a majority of said impact modifier dissolves in or absorbs said acrylic based monomer, methacrylic ester based monomer, and mixtures thereof.

15. The adhesive composition as defined in claim 13, wherein said impact modifier and said acrylic based monomer, methacrylic ester based monomer, and mixtures thereof are selected so that a majority of said impact modifier dissolves in or absorbs said acrylic based monomer, methacrylic ester based monomer, and mixtures thereof.

16. The adhesive composition as defined in claim 1, comprising by weight percent:

| Acrylate and/or methacrylate monomer | more than 50% and up to 90% |
|---|---|
| Elastomer | 0.1-15% |
| Impact modifier | 0.01-25% |

17. The adhesive composition as defined in claim 1, comprising by weight percent:

| | |
|---|---|
| Acrylate and/or methacrylate monomer | 55-80% |
| Elastomer | 0.5-10% |
| Impact modifier | 0.5-20% |
| % elongation prior to failure | over 50% |

18. The adhesive composition as defined in claim 1, comprising by weight percent:

| | |
|---|---|
| Acrylate and/or methacrylate monomer | 55-75% |
| Elastomer | 1-8% |
| Impact modifier | 2-20% |
| % elongation prior to failure | over 60% |

19. The adhesive composition as defined in claim 1, comprising by weight percent:

| | |
|---|---|
| Acrylate and/or methacrylate monomer | 60-70% |
| Elastomer | 2-7% |
| Impact modifier including | 5-18% |
| at least 5% MBS | |
| % elongation prior to failure | over 75% |

20. The adhesive composition as defined in claim 1, comprising by weight percent:

| | |
|---|---|
| Acrylate and/or methacrylate monomer | 60-68% |
| Elastomer including | 2-6% |
| at least 25% urethane rubber | |
| and/or urethane pre-polymers | |
| and/or polyols | |
| Impact modifier including | 5-17% |
| at least 10% MBS | |
| % elongation prior to failure | over 80% |

21. The adhesive composition as defined in claim 1, comprising by weight percent:
PART A

| | |
|---|---|
| MMA Monomer | 50-75% |
| Impact modifier including | 0.5-20% |
| at least 20% MBS | |
| Secondary monomers | 0-10% |
| Polyether Prepolymer | 0-12% |
| Hypalon 30 Rubber | 0-20% |
| Plasticizer | 0-8% |
| Hydroperoxide | 0-2% |
| UV absorber | 0-2% |
| Wetting agent | 0-2% |
| Other additives | 0-15% |

PART B

| | |
|---|---|
| MMA Monomer | 50-75% |
| Impact modifier including | 0.5-20% |
| at least 20% MBS | |
| Secondary monomers | 0-10% |
| Tertiary amine curing agent | 0-6% |
| Copper Acetylacetonate | 0-0.05% |
| Phenyl Di Hydro Pyridine | 0-5% |
| Plasticizer | 0-8% |
| Other additives | 0-15% |

22. A 10:1 adhesive composition comprising over 50 weight percent to up to about 95 weight percent acrylic based monomer, methacrylic ester based monomer, and mixtures thereof; 0.01-30 weight percent impact modifier; about 1-25 weight percent elastomer, and catalyst; said elastomer including urethane elastomer, said impact modifier including methacrylate-butadiene-styrene copolymer, said catalyst including peroxide, said adhesive composition having an elongation at failure that is greater than about 45%.

23. The 10:1 adhesive composition as defined in claim 22, wherein a majority weight percent of said acrylic based monomer, methacrylic ester based monomer, and mixtures thereof includes methyl methacrylate monomer, a majority weight percent of said impact modifier includes a methacrylate-butadiene-styrene copolymer, a majority weight percent of said elastomer includes urethane elastomer.

24. A 1:1 adhesive composition comprising over 50 weight percent to up to about 95 weight percent acrylic based monomer, methacrylic ester based monomer, and mixtures thereof; 0.01-30 weight percent impact modifier; about 1-25 weight percent elastomer, chlorosulfonated polyethylene synthetic rubber, dihydropyridine; said elastomer including urethane elastomer, said impact modifier including methacrylate-butadiene-styrene copolymer, said adhesive composition having an elongation at failure that is greater than about 45%.

25. The 1:1 adhesive composition as defined in claim 24, wherein a majority weight percent of said acrylic based monomer, methacrylic ester based monomer, and mixtures thereof includes methyl methacrylate monomer, a majority weight percent of said impact modifier includes a methacrylate-butadiene-styrene copolymer, a majority weight percent of said elastomer includes urethane elastomer.

26. The 1:1 adhesive composition as defined in claim 24, including epoxy resin.

27. The 1:1 adhesive composition as defined in claim 25, including epoxy resin.
